(19) United States
(12) Patent Application Publication
(10) Pub. No.: US 2008/0017778 A1
(43) Pub. Date: Jan. 24, 2008

(54) MOUNTING APPARATUS FOR DATA STORAGE DEVICE

(75) Inventors: CHEN-LU FAN, Tu-Cheng (TW); LI-PING CHEN, Tu-Cheng (TW); CHIEH YANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,196

(22) Filed: Jul. 13, 2006

(51) Int. Cl. H01Q 1/12

(52) U.S. Cl. 248/539

(57) ABSTRACT

A mounting apparatus for a data storage device (50) includes a bracket (30) for receiving the data storage device, a case (10) for receiving the bracket, and at least one gasket (19) attached on the case and extending therein. When the bracket is slid into the case, the at least one gasket abuts against the bracket.

### 1. FIELD OF THE INVENTION

The present invention relates to a mounting apparatus for a data storage device, and more particularly to an apparatus with simple structure and has good shock absorbing ability.

### 2. DESCRIPTION OF RELATED ART

A conventional data storage device mounting assembly is usually directly mounted to a metal bracket of a computer enclosure with a plurality of screws or a mounting member such as a latch. The data storage device will absorb vibration of the bracket when the computer enclosure is disassembled and tested. The vibration may damage the data storage devices.

An improved mounting apparatus for securing a data storage device is disclosed. The apparatus includes a bracket assembly and a plurality of resilient gaskets. The data storage device defines a plurality of fixing apertures. The bracket assembly includes a first bracket, and a second bracket. The first bracket includes a bottom panel, and a side panel extending up from the bottom panel. The second bracket includes a vertical plate, and a horizontal plate perpendicular to the vertical plate. The horizontal plate is secured to the bottom panel of the first bracket. The vertical plate is moved outwardly relative to the first bracket when the data storage device is placed in the bracket assembly. A plurality of positioning strips extends perpendicularly from the bracket assembly to position the resilient gaskets respectively. A tab extends from some of the positioning strips to engage in the fixing holes of the storage device. However, the resilient gaskets are positioned in such a way as make it easy for them to drop out of the bracket, and an additional horizontal plate is needed to assemble the data storage device.

What is needed, therefore, is to provide a simple mounting apparatus for data storage devices which has good shock absorbing ability.

### SUMMARY OF THE INVENTION

A mounting apparatus for a data storage device includes a bracket for receiving the data storage device, a case for receiving the bracket, and at least one gasket attached on the case and extending therein. When the bracket is slid into the case, the at least one gasket abuts against the bracket.

Other advantages and novel features will be drawn from the following detailed description of a preferred embodiment with attached drawings, in which:

### BRIEF DESCRIPTION OF THE DRAWINGS

FIG. 1 is an exploded, isometric view of a mounting apparatus for a data storage device of a preferred embodiment of the present invention, the mounting apparatus including a case, a bracket, and a plurality of gaskets;

FIG. 2 is an enlarged, isometric view of one gasket of FIG. 1;

FIG. 3 is an assembled view of the data storage device and the bracket of FIG. 1; and

FIG. 4 is an assembled view of FIG. 1.

### DETAILED DESCRIPTION OF THE INVENTION

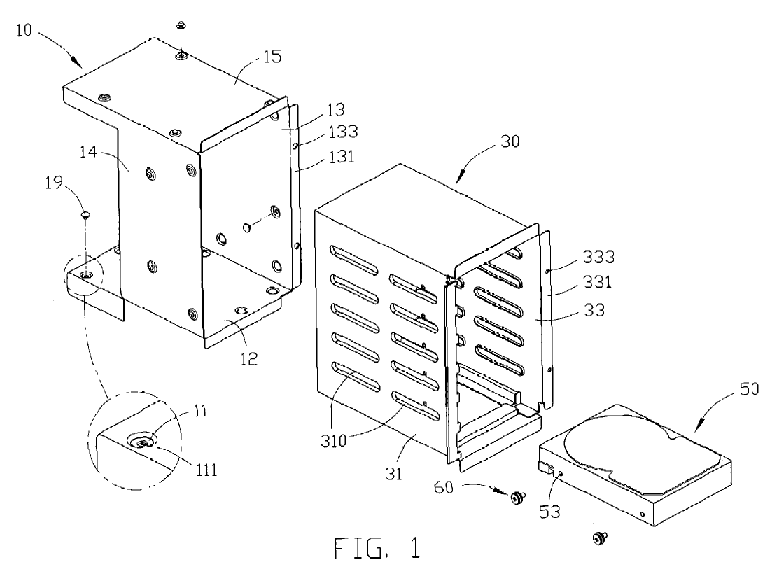

Referring to FIG. 1, a mounting apparatus for an electronic component like a data storage device 50 of an electronic device like a computer includes a case 10, a bracket 30, and a plurality of resilient cup gaskets 19 for attaching to the case 10.

The case 10 includes a bottom plate 12, a pair of side plates 13, 14, and a top plate 15 cooperatively forming a frame with a rectangular channel defined therethrough. A fixing flange 131 is perpendicularly formed on the side panel 13. Two securing holes 133 are defined in the fixing flange 131. A plurality of round recesses 11 is defined in an inner side of each plate 12-15. A through hole 111 is defined in each of the recesses 11.

The bracket 30 for receiving the data storage device 50 includes a bottom panel, a pair of side panels 31, 33, and a top panel. The bracket 30 is similar to the case 10, but having smaller dimensions so that it may be received in the rectangular channel of the case 10. Each panel of the bracket 30 has a flange on a front side edge thereof. Two securing holes 333 are defined in a flange 33 of the bracket 30 corresponding to the securing holes 133 of the case 10. A plurality of slots 310 is defined and aligned in a vertical direction in each side panel 31 of the bracket 30. Every two adjacent slots 310 are aligned in a horizontal direction. The data storage device 50 has a pair of screw holes 53 in each side wall.

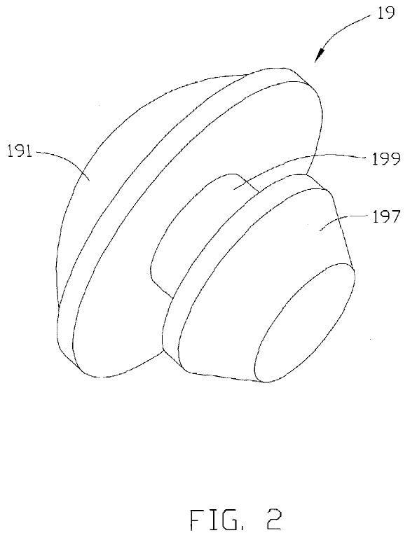

Referring also to FIG. 2, the cap gasket 19 has a mushroom shape. The cap gasket 19 includes a resilient head 191, a resilient tapered foot 197, and a neck 199. The resilient tapered foot 197 tapers from a top portion having a diameter greater than the through hole 111 to a bottom portion having a smaller diameter than the through hole 111 of the case 10.

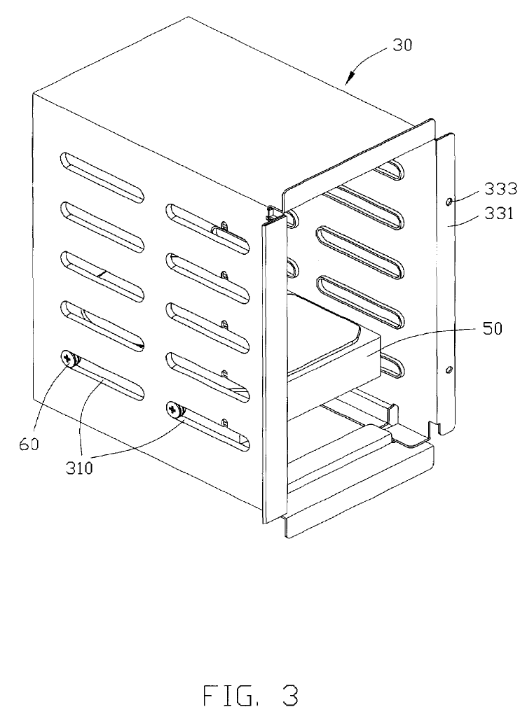

Referring also to FIG. 3, when assembling the data storage device 50 to the bracket 30, the data storage device 50 is positioned in the bracket 30 with each screw hole 53 approachable through the slot 310 on a same plane of the bracket 30. The screws 60 are secured into the screw holes 53 through the corresponding slots 310, so that the data storage device 50 is securely attached to the bracket 30.

When attaching the cup gaskets 19 into the case 10, the foot 197 of each cup gasket 19 is pushed through the through hole 111 of the recess 11 from an inner side of the case 10. Thus the cup gaskets 19 are assembled into the plates of the case 10 with the heads 191 protrude into the inner space of the case 10.

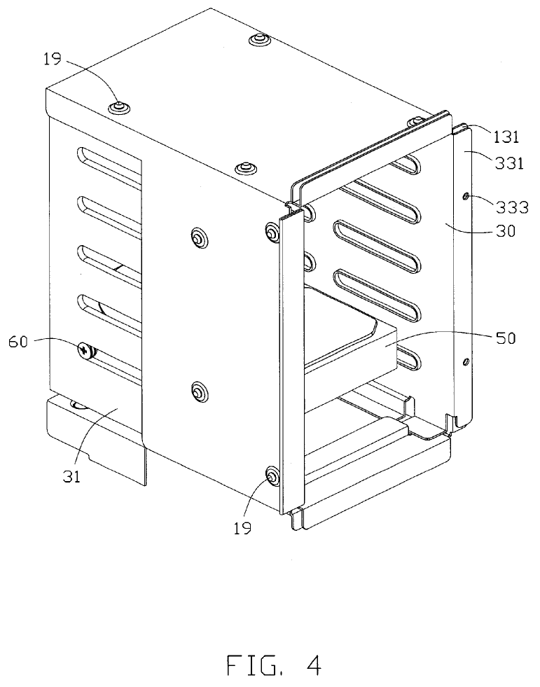

Referring also to FIG. 4, when assembling the bracket 30 to the case 10, the bracket 30 is slid into the case 10. The cup gaskets 19 abut against an outer surface of the bracket 30 to decrease vibration. The fixing flange 13 of the case 10 abuts on the flange 331 of the bracket 30 with fasteners (not shown) securing through the securing holes 133 and the securing holes 333. Thus, the bracket 30 is conveniently secured to the case 10.

It is to be understood, however, that even though numerous characteristics and advantages have been set forth in the foregoing description of a preferred embodiment, together with details of the structure and function of the preferred embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mounting apparatus for a data storage device, comprising:
a bracket for receiving the data storage device;
a case for receiving the bracket; and
at least one gasket attached on the case and extending therein, wherein when the bracket is slid into the case, the at least one gasket abuts against the bracket.

2. The mounting apparatus as described in claim 1, wherein the case comprises a bottom plate and a pair of side plates, and at least one of the bottom plate and the pair of side plates has at least one gasket attaching thereon.

3. The mounting apparatus as described in claim 1, wherein at least one recess is defined in an inner surface of the case, a through hole is defined in each recess, and the at least one gasket extends therethrough.

4. The mounting apparatus as described in claim 1, wherein the gasket has a mushroom shape.

5. The mounting apparatus as described in claim 4, wherein the gasket comprises a resilient head and a resilient tapered foot.

6. The mounting apparatus as described in claim 1, wherein the bracket comprises a pair of side panels and a bottom panel, and at least one slot is horizontally defined in each of the side panels.

7. The mounting apparatus as described in claim 6, wherein a screw is provided for securing the data storage device to the bracket though the slot.

8. The mounting apparatus as described in claim 1, wherein the dimensions of bracket are less than the dimensions of the case.

9. The mounting apparatus as described in claim 1, wherein at least one flange is bent from the bracket, and a securing hole is defined therein for securing the bracket with the case.

10. A bracket assembly with shock absorbing ability, comprising:
a case defining a through hole;
a bracket attached in the case; and
at least one gasket attached on the case, each gasket comprising a resilient head and a resilient tapered foot, wherein the foot extends through the though hole of the case, and the head is sandwiched between the case and the bracket.

11. The bracket assembly as described in claim 10, wherein the case comprises a bottom plate and a pair of side plates, and at least one of the bottom plate and the pair of side plates has at least one gasket extending therein.

12. The bracket assembly as described in claim 10, wherein at least one recess is defined in an inner surface of the case, and a through hole is defined in each recess.

13. The bracket assembly as described in claim 10, wherein the bracket comprises a pair of side panels and a bottom panel, and at least one slot is horizontally defined in each of the side panels.

14. The bracket assembly as described in claim 13, wherein at least one screw is provided for securing a data storage device to the bracket through the slot.

15. The bracket assembly as described in claim 10, wherein the dimensions of bracket are less than the dimensions of the case.

16. The bracket assembly as described in claim 10, wherein at least one flange is bent from the bracket, and a securing hole is defined therein for securing the bracket with the case.

17. The bracket assembly as described in claim 10, wherein the gasket has a mushroom shape.

18. An electronic device comprising:
a case installable in said electronic device and defining a first space therein;
a bracket removably installable in said first space of said case, and defining a second space therein;
an electronic component functioning for said electronic device, and removably installable in said second space of said bracket to be movable together with said bracket into and out of said first space of said case; and
at least one resilient gasket embedded in said case to expose exclusively a resilient head thereof into said space so as to be engagable with said bracket and provide impact buffer between said case and said bracket.

19. The electronic device as described in claim 18, wherein said gasket further comprises a resilient tapered foot extending away from said first space of said case.

20. The electronic device as described in claim 18, wherein said case defines a recess beside said first space to allow said gasket embedded therein.
